(19) United States
(12) Patent Application Publication
(10) Pub. No.: US 2017/0116080 A1
(43) Pub. Date: Apr. 27, 2017

(54) REQUESTING AVOIDANCE/PREFERENCE OF WHICH DISPERSED STORAGE UNITS TO USE ON A WRITE OR RETRIEVAL REQUEST

(71) Applicant: International Business Machines Corporation, Armonk, NY (US)

(72) Inventors: Michael W. Marchant, Chicago, IL (US); Jason K. Resch, Chicago, IL (US)

(21) Appl. No.: 15/399,426

(22) Filed: Jan. 5, 2017

Related U.S. Application Data
(63) Continuation-in-part of application No. 15/082,887, filed on Mar. 28, 2016.
(60) Provisional application No. 62/168,145, filed on May 29, 2015.

(51) Int. Cl. G06F 11/10; G06F 3/06

(52) U.S. Cl. CPC G06F 11/1076; G06F 3/0619; G06F 3/064; G06F 3/067

(57) ABSTRACT

A method includes determining, by a requesting device of a dispersed storage network (DSN), a storage directive regarding storage of a data segment of a data object based on one or more of: data type of the data object, DSN access restrictions of the requesting device, and a data storage report. The method further includes sending a write request including the storage directive to a DSN processing unit. The method further includes validating the write request in light of the storage directive and when the write request is valid, dispersed storage error encoding the data segment to produce a set of encoded data slices, selecting a set of storage units based on the storage directive, generating a set of slice names for the set of encoded data slices based on the selected set of storage units, and sending a set of write requests to the selected set of storage units.

### CROSS REFERENCE TO RELATED APPLICATIONS

The present U.S. Utility patent application claims priority pursuant to 35 U.S.C. §120, as a continuation-in-part (CIP) of U.S. Utility patent application Ser. No. 15/082,887, entitled “TRANSFERRING ENCODED DATA SLICES IN A DISPERSED STORAGE NETWORK,” filed Mar. 28, 2016, pending, which claims priority pursuant to 35 U.S.C. §119(e) to U.S. Provisional Application No. 62/168,145, entitled “TRANSFERRING ENCODED DATA SLICES BETWEEN STORAGE RESOURCES,” filed May 29, 2015, expired, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

Technical Field of the Invention

This invention relates generally to computer networks and more particularly to dispersing error encoded data.

Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

As is further known, regulatory, performance, and/or security-based restrictions, may require computing devices within a dispersed storage system to adjust dispersed storage techniques accordingly.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of another embodiment of a dispersed storage network (DSN) in accordance with the present invention;

FIG. 11 is a schematic block diagram of an example of selecting a set of storage units based on a storage directive of a requesting device in accordance with the present invention;

FIG. 12 is a schematic block diagram of an example of DSN address ranges of a set of storage units in accordance with the present invention;

FIG. 13 is a schematic block diagram of an example of generating a slice name that functions as a DSN address in accordance with the present invention;

FIG. 14 is a schematic block diagram of an example of selecting one or more DSNs of a plurality of DSNs based on a storage directive in accordance with the present invention; and

FIG. 15 is flowchart illustrating an example of performing a write request based on a storage directive of a requesting device in accordance with the present invention.

### DETAILED DESCRIPTION OF THE INVENTION

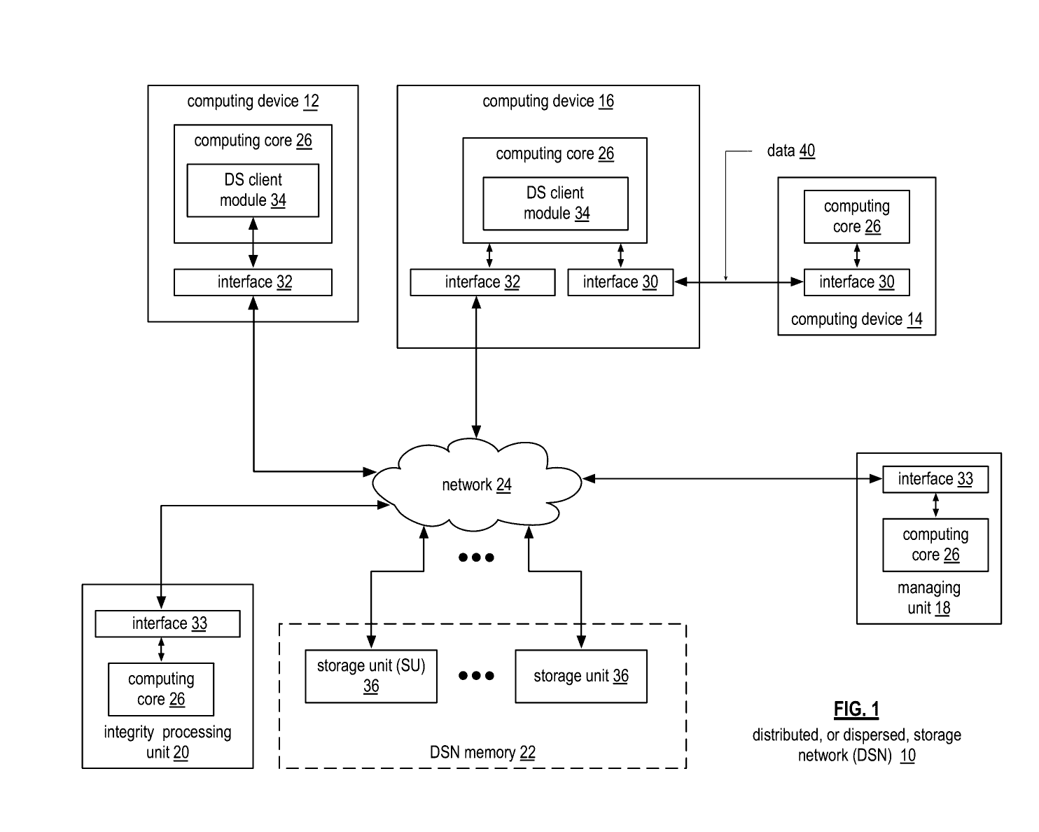

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

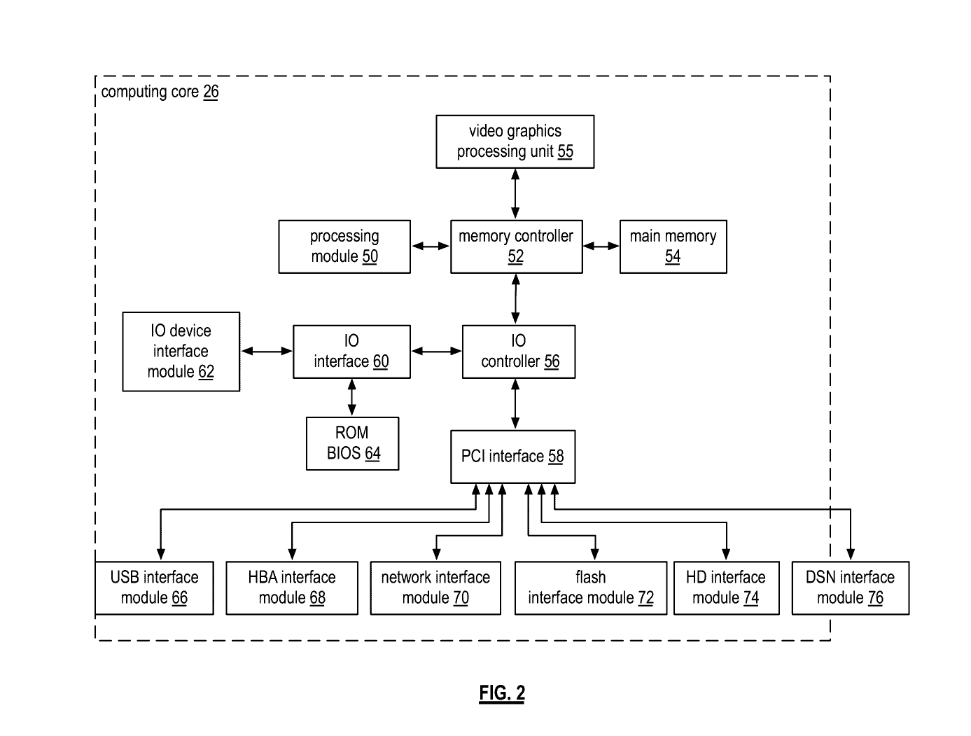

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

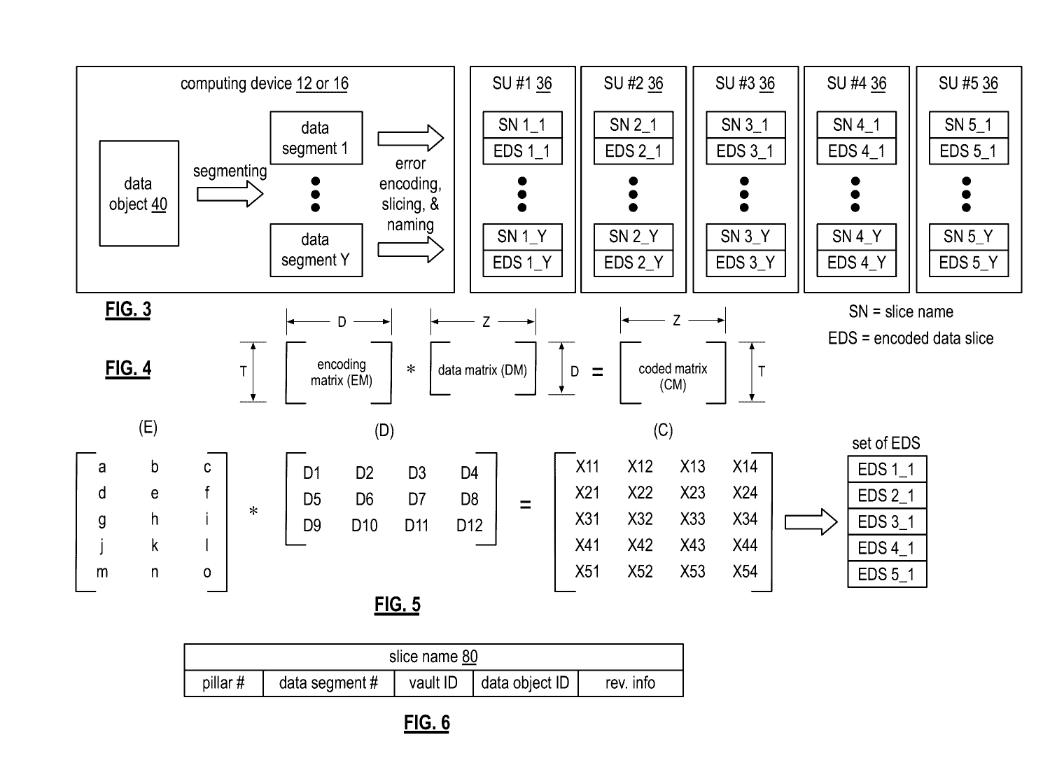

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

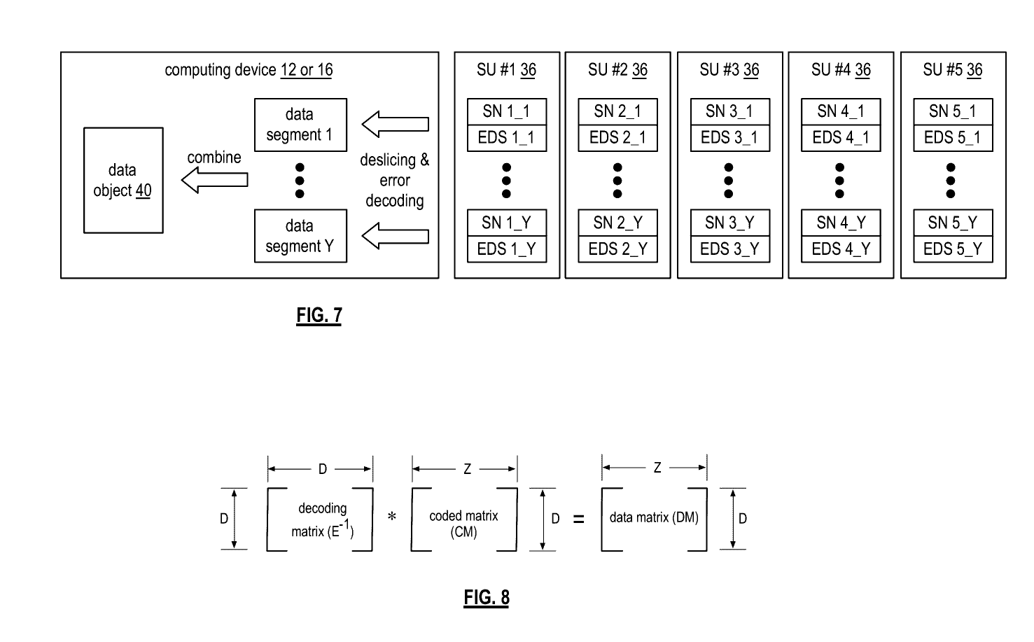

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

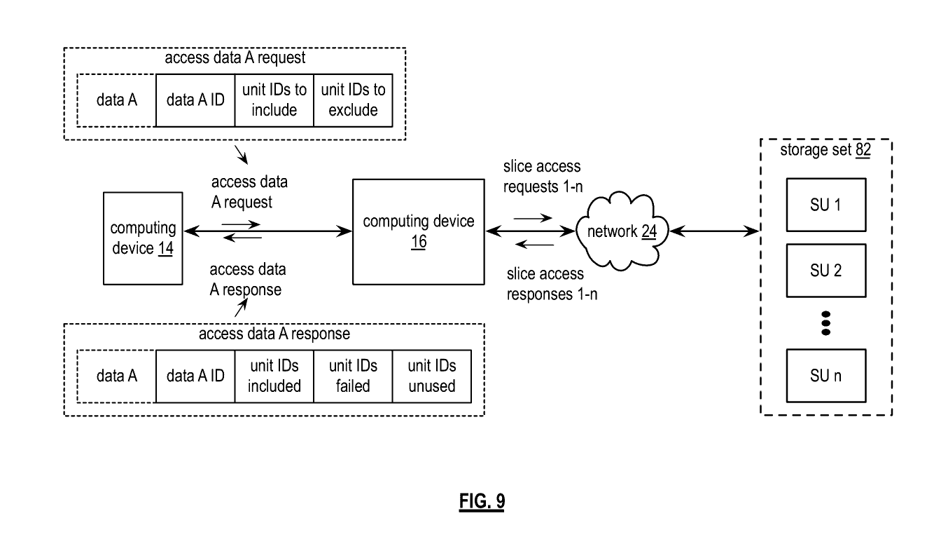

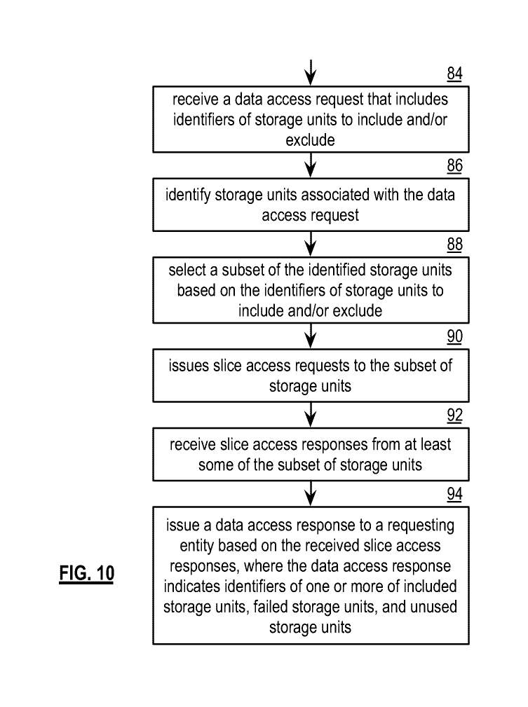

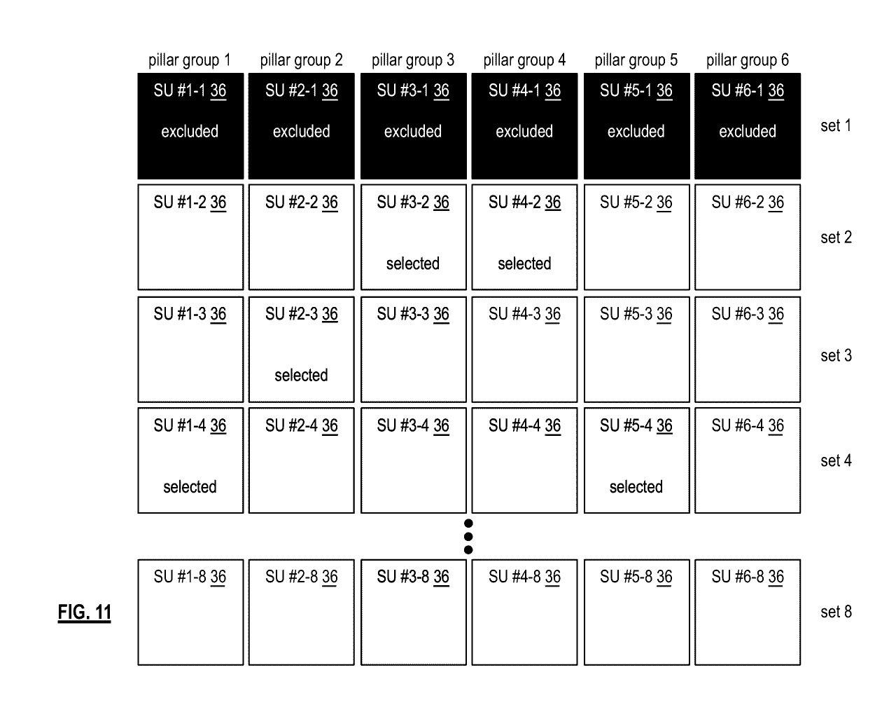

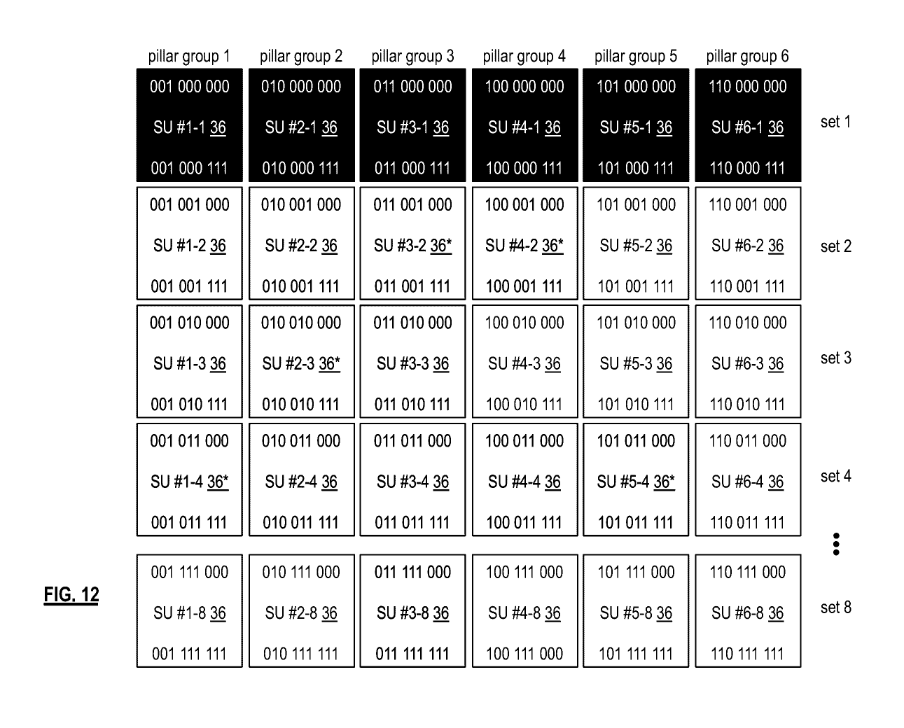

FIG. 9 is a schematic block diagram of another embodiment of a dispersed storage network (DSN) that includes the computing device 14 of FIG. 1, the computing device 16 of FIG. 1, the network 24 of FIG. 1, and a storage set 82. The storage set 82 includes a set of storage units 1-n. The DSN functions to select storage units for data access.

In an example of operation of the selecting of the storage units for the data access, the computing device 16 receives a data access request from the computing device 14 (e.g., a user device), where the data access request includes one or more of a request type indicator, a data identifier, a data for storage, one or more identifiers of storage units to include in encoded data slice access operations, and one or more identifiers of storage units to exclude from the encoded data slice access operations. For example, the computing device 16 receives a data access A request that includes data A, an identifier (ID) of data A, unit identifiers of storage units to include, and unit identifiers of storage units to exclude.

Having received the data access request, the computing device 16 identifies storage units of the storage set 82 associated with the received data access request. The identifying includes at least one of determining a DSN address based on the data identifier and interpreting a DSN address mapping to identify the storage set. Having identified the storage units, the computing device 16 selects a subset of the identified storage units based on the data access request and dispersal parameters associated with the data (e.g., based on a vault identifier, based on an identifier of a requesting entity). For example, the computing device 16 selects a threshold number (e.g., a read threshold number for a read operation, a write threshold number for a write operation) of storage units from the identified storage units, where the selected storage units may include desired storage units to include and excludes desired storage units to exclude.

Having selected the subset of identify storage units, the computing device 16 issues slice access requests to the subset of storage units in accordance with the data access request. For example, the processing module generates read slice access requests for the read operation or generates write slice access requests for the write operation, and sends, via the network 24, the slice access requests to the selected storage units of the storage set.

Having issued the slice access request, the computing device 16 receives slice access responses from at least some of the subset of storage units. The receiving may further include the computing device 16 indicating identifiers and included storage units, filled storage units, and unused storage units. Having received the slice access responses, the computing device 16 disperse storage error decodes received encoded data slices to reproduce data when the request type indicator is the read operation.

Having received the slice access responses, the computing device 16 issues a data access response to the computing device 14, where the data access response includes one or more of the reproduced data, the data identifier, identifiers of storage units included, identifiers of filled storage units, and identifiers of unused storage units. For example, the computing device 16 generates a data access response A and sends the data access response A to the computing device 14.

FIG. 10 is a flowchart illustrating an example of selecting storage units for data access within a dispersed storage network (DSN) memory. The method begins or continues at a step 84 where a processing module (e.g., of computing device 16) receives a data access request that includes identifiers of storage units to include and/or exclude. The method continues at the step 86 where the processing module identifies storage units associated with the data access request. For example, the processing module determines a DSN address based on a data identifier of the data access request and interprets a DSN address mapping to identify the storage units.

The method continues at the step 88 where the processing module selects a subset of the identified storage units based on identifiers of storage units to include and/or exclude. For example, the processing module selects a threshold number (e.g., a read threshold number for a read operation, a write threshold number for a write operation) of storage units from the identified storage units, where the selected storage units may include desired storage units to include and excludes desired storage units to exclude.

The method continues at the step 90 where the processing module issues slice access requests to the subset of storage units. For example, the processing module generates read slice access requests for a read operation, generates write slice access request for a write operation, and sends the slice access requests to the subset of storage units. The method continues at the step 92 where the processing module receives a slice access response from at least some of the subset of storage units. The receiving includes indicating identifiers of included storage units, identifiers of filled storage units, and identifiers of unused storage units. The receiving may further include dispersed storage error decoding received encoded data slices to reproduce data when the request type indicator is the read operation.

The method continues at the step 94 where the processing module issues a data access response to a requesting entity based on the received slice access responses, where the data access response indicates identifiers of one or more of included storage units, filled storage units, and unused storage units. For example, the processing module generates the data access response and sends the data access response to the requesting entity (e.g., computing device 14).

FIG. 11 is a schematic block diagram of an example of selecting a set of storage units based on a storage directive of a requesting device. The requesting device of a dispersed storage network (DSN) (e.g., computing device 14) may send a write request regarding the storage of a data segment of a data object to a DSN processing unit (e.g., the processing module of computing device 16) that includes a storage directive. The requesting device determines the storage directive based on one or more of data type of the data object, DSN access restrictions of the requesting device, and a data storage report. The storage directive includes a list of storage units that are preferred for storage and a list of storage units that should be excluded from storage. The storage directive may also include one or more DSNs of a plurality of DSNs that should be included in or excluded from storage operations.

The requesting device may wish to exclude or include certain storage units for several reasons. For example, the data type of the data object may necessitate a particular method of storage that is only provided by certain DSNs and/or storage units of a DSN. For instance, a data object may be a sensitive data type that requires a higher level of security for storage. Based on this data type, the requesting device may include a list of storage units that are part of a private network (as opposed to a virtual private network (“VPN”) where others may obtain access) as preferred storage units in its storage directive. As another example, DSN access restrictions may dictate which storage units the requesting device may write to. The requesting device may maintain a list of the identity of storage units of the DSN that it is authorized to access and/or that it is unauthorized to access. Further, the requesting device may maintain a list of the identity of one or more DSNs of a plurality of DSNs it is authorized to access and/or that it is unauthorized to access. Based on these DSN access restrictions, the requesting device can direct the write request to storage units and or DSNs that it is authorized to access. For instance, the requesting device may be unauthorized to write to storage units or DSNs that are located in certain regions or geographies due to regulatory compliance. In that case, the requesting device would add the storage units from those regions to an exclusion list in the storage directive.

Further, the requesting device's data storage report informs the requesting device of which storage units and/or DSNs to include or exclude based on past storage operations. The data storage report includes the identity of any storage units that have provided favorable and/or unfavorable write responses (e.g., the storage unit was stalled, overloaded, or was experiencing some other kind of performance issue) in the past. The data storage report keeps track of storage units that failed to provide write responses in the past (e.g., the storage unit was inoperable or never received the request due to a network connection issue). The data storage report also logs the storage units or DSNs that have been excluded in the past. If the data storage report indicates that certain storage units are untrustworthy or do not meet performance requirements, the requesting device will add those storage units to the exclusion list in the storage directive.

When the requesting device determines the storage directive based on the data type of the data object, the DSN access restrictions of the requesting device, and the data storage report, the requesting device sends a write request that includes the storage directive to the DSN processing unit. The DSN processing unit then validates the write request in light of the storage directive. For example, if the storage directive includes a list of storage units to include in the write request, the DSN processing unit verifies that the requesting device is in fact authorized to write to those storage units. Once the DSN processing unit determines that the write request is valid in light of the storage directive, the DSN processing unit dispersed storage error encodes the data segment to produce a set of encoded data slices. The set of encoded data slices includes a pillar number of encoded data slices, where a decode threshold number of encoded data slices is required to recover the data segment, and the decode threshold number is less than the pillar number.

The example in FIG. 11 shows eight sets of storage units and six pillar groupings. Storage unit set 1 includes SU#1-1 through SU#6-1 where SU #1-1 is in pillar grouping 1, SU #2-1 is in pillar grouping 2, SU #3-1 is in pillar grouping 3, SU #4-1 is in pillar grouping 4, SU #5-1 is in pillar grouping 5, and SU #6-1 is in pillar grouping 6. Similar organization is present for storage unit sets 2-8. The DSN processing unit selects a set of storage units from a plurality of storage units based on the storage directive, where the selected set of storage units includes a storage unit from each pillar grouping of storage units of the pillar number of groupings of storage units of the plurality of storage units. Alternatively, or in addition to, the DSN processing unit may identify preferred storage units within each pillar grouping of storage units based on the storage directive. The DSN processing unit then obtains storage capability and reliability (e.g., available memory, latency, TO rate, percentage of time online, etc.) data of the preferred storage units. The DSN processing unit may then select the set of storage units from the preferred storage units in accordance with the storage capability and reliability data.

As shown, the storage directive indicated that the DSN processing unit exclude the storage units in storage unit set 1 from receiving the write request. This set may be excluded for many reasons such as past performance issues indicated in the data storage report, DSN access restrictions, and/or undesirable level of security for the type of data to be stored.

The storage directive further indicated that the DSN processing unit may include SU #1-2, SU #2-2, SU #3-2, and SU #4-2 from the storage unit set 2, SU #1-3, SU #2-3, and SU #3-2 from the storage unit set 3, SU #1-4, SU #2-4, SU #3-4, SU #4-4, and SU #5-4 from the storage unit set 4, and SU #3-8 from storage unit set 8. Of the included storage units, the DSN processing unit may select a pillar number of storage units, one storage unit from each pillar grouping, to store the encoded data slices. For example, here, the pillar number is five and the a decode threshold is three. The DSN processing unit selects five storage units of the thirteen included storage units as the selected set of storage units where each storage unit of the selected set of storage units is from a different pillar grouping. As shown, SU #1-4 is selected from pillar grouping 1, SU #2-3 is selected from pillar grouping 2, SU #3-2 is selected from pillar grouping 3, SU #4-2 is selected from pillar grouping 4, and SU #5-4 is selected from pillar grouping 5.

As another example, the storage directive may include the identity of a first storage unit for storing a first encoded data slice, the identity of a second storage unit of the selected set of storage units for storing a second encoded data slice of the set of encoded data slices, identity of a third storage unit of the selected set of storage units for storing a third encoded data slice of the set of encoded data slices, and the identity of further storage units to store additional encoded data slices of the set of encoded data slices. If the storage directive identifies which encoded data slices go to which storage units, the DSN processing unit simply follows that directive.

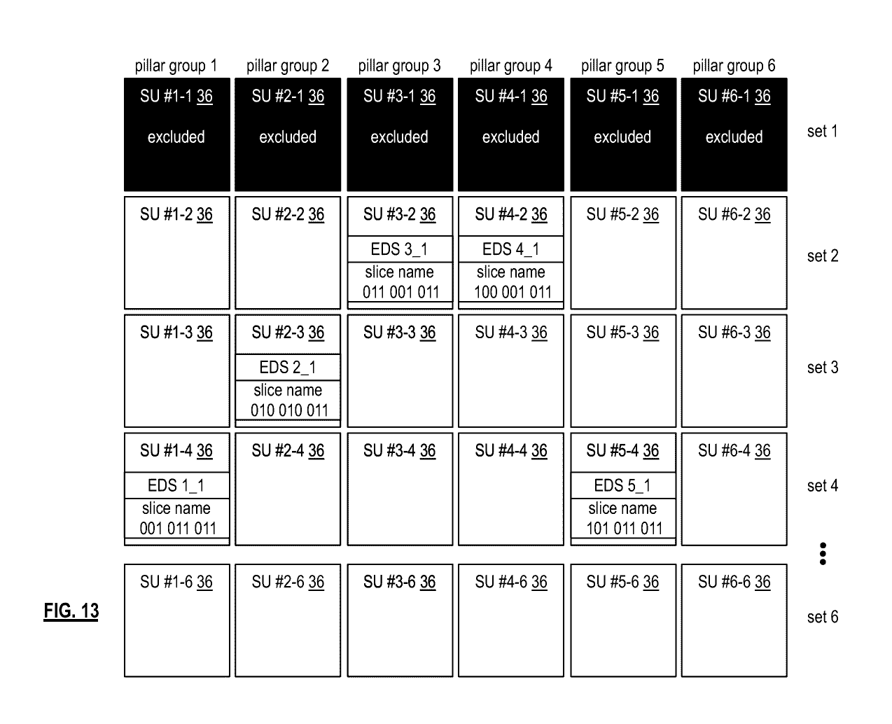

The DSN processing unit then generates a set of slice names for the set of encoded data slices based on the selected set of storage units, where a first slice name is generated for a first encoded data slice of the set of encoded data slices for storage in a first storage unit of the set of storage units. This process continues for each encoded slice that will be stored in the selected set of storage units. A more detailed discussion of generating the set of slice names for the set of encoded data slices based on the selected set of storage units will be discussed subsequently with reference to one or more of FIGS. 12-13.

The DSN processing unit then sends a set of write requests to the selected set of storage units, where a first write request of the set of write requests includes the first encoded data slice and the first slice name, and where the first write request is sent to the first storage unit. This process is continued until write requests are sent to all of the storage units in the selected set regarding the encoded data slices to be stored.

The requesting device will receive write responses from at least some of the storage units of the selected set of storage units in response to the write requests. Based on these write responses, the requesting device can update the data storage report to include the identity of storage units that provided a favorable write response, the identity of storage units that provided an unfavorable write response, the identity of storage units that provided no write response, and the identity of storage units not included in the selected set of storage units. For example, if a selected storage unit returns an unfavorable write response (e.g., the storage unit stalled or operated too slowly), the requesting device may use that information to adjust future storage directives (e.g., the requesting device may add the stalled or slow storage unit to the exclusion list if that storage unit has become unreliable or less desirable for storage).

FIG. 12 is a schematic block diagram of an example of DSN address ranges of a set of storage units. For simplicity, the DSN addresses shown are represented by nine bits with the first three bits corresponding to the pillar grouping number. For example, SU #1-1 from pillar grouping 1, storage unit set 1 has a DSN address range of 001 000 000 through 001 000 111. The next storage unit in pillar grouping 1 (SU #1-2) has a DSN address range that follows consecutively after the DSN addresses of SU #1-1 as 001 001 000 through 001 001 111. In this example, included storage units are grey, excluded storage units are black, and selected storage units are grey with an asterisk next to the storage unit number. Selected storage unit SU #1-4 has a DSN address range of 001 011 000 through 001 011 111. Selected storage unit SU #2-3 has a DSN address range of 010 010 000 through 010 010 111. Selected storage unit SU #3-2 has a DSN address range of 011 001 000 through 011 001 111. Selected storage unit SU #4-2 has a DSN address range of 100 001 000 through 100 001 111. Selected storage unit SU #5-4 has a DSN address range of 101 011 000 through 101 011 111. As will be discussed subsequently with reference to FIG. 13, the DSN processing unit will generate a slice name for the encoded data slices using a DSN address of the DSN address ranges of the selected storage units.

FIG. 13 is a schematic block diagram of an example of generating a slice name that functions as a DSN address. A typical format for a slice name includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22. As discussed previously with reference to FIG. 12, for simplicity, the DSN addresses are represented with nine bits with the first three bits corresponding to the pillar grouping number. Therefore, in this example a slice name will include a pillar number (first three bits), a data segment number (second three bits), and a vault identifier (last three bits). However, the slice name may include more information and thus more bits in other examples.

After verifying that the write request including the storage directive sent from the requesting device is valid, the DSN processing unit dispersed storage error encodes the data segment to produce a set of encoded data slices. The set of encoded data slices includes a pillar number of encoded data slices, where a decode threshold number of encoded data slices is required to recover the data segment, and the decode threshold number is less than the pillar number.

In this example, the DSN processing unit then selected storage units SU #1-4, SU #2-3, SU #3-2, SU #4-2, and SU #5-4 as the selected set of storage units based on the storage directive sent by the requesting device. The selected set of storage units includes a pillar number (e.g., five) of storage units, where each storage unit is selected from a different pillar grouping of storage units. The DSN processing unit then generates a set of slice names for the set of encoded data slices based on the selected set of storage units, where a first slice name is generated for a first encoded data slice of the set of encoded data slices for storage in a first storage unit of the set of storage units. This process is continued for each encoded slice that will be stored in the selected set of storage units.

For example, the data segment has been dispersed error encoded into five error encoded data slices EDS 1_1, EDS 2_1, EDS 3_1, EDS 4_1, and EDS 5_1. The pillar number is five therefore a selected storage unit from pillar groupings 1-5 will each store a slice respectively. The decode threshold number is three such that three slices are required to obtain the data segment. For storage in selected storage unit SU #1-4, the DSN processing unit generated a slice name 001 011 011 for EDS 1_1 which is within SU #1-4's DSN address range address range of 001 011 000 through 001 011 111. For storage in selected storage unit SU #2-3, the DSN processing unit generated a slice name 010 010 011 for EDS 2_1 which is within SU #2-3's DSN address range address range of 010 010 000 through 010 010 111. For storage in selected storage unit SU #3-2, the DSN processing unit generated a slice name 011 001 011 for EDS 3_1 which is within SU #3-2's DSN address range address range of 011 001 000 through 011 001 111. For storage in selected storage unit SU #4-2, the DSN processing unit generated a slice name 100 001 011 for EDS 4_1 which is within SU #4-2's DSN address range address range of 100 001 000 through 100 001 111. For storage in selected storage unit SU #5-4, the DSN processing unit generated a slice name 101 011 011 for EDS 5_1 which is within SU #5-4's DSN address range address range of 101 011 000 through 101 011 111.

After the slice names are generated, the DSN processing unit sends a set of write requests to the selected set of storage units where a first write request of the set of write requests includes the first encoded data slice and the first slice name, and where the first write request is sent to the first storage unit. In this example, the DSN processing unit sends a first write request to SU #1-4 that includes EDS 1_1 and EDS 1_1's slice name. The DSN processing unit sends a second write request to SU #2-3 that includes EDS 2_1 and EDS 2_1's slice name. The DSN processing unit sends a third write request to SU #3-2 that includes EDS 3_1 and EDS 3_1's slice name. The DSN processing unit sends a fourth write request to SU #4-2 that includes EDS 4_1 and EDS 4_1's slice name. The DSN processing unit sends a fifth write request to SU #5-4 that includes EDS 5_1 and EDS 5_1's slice name.

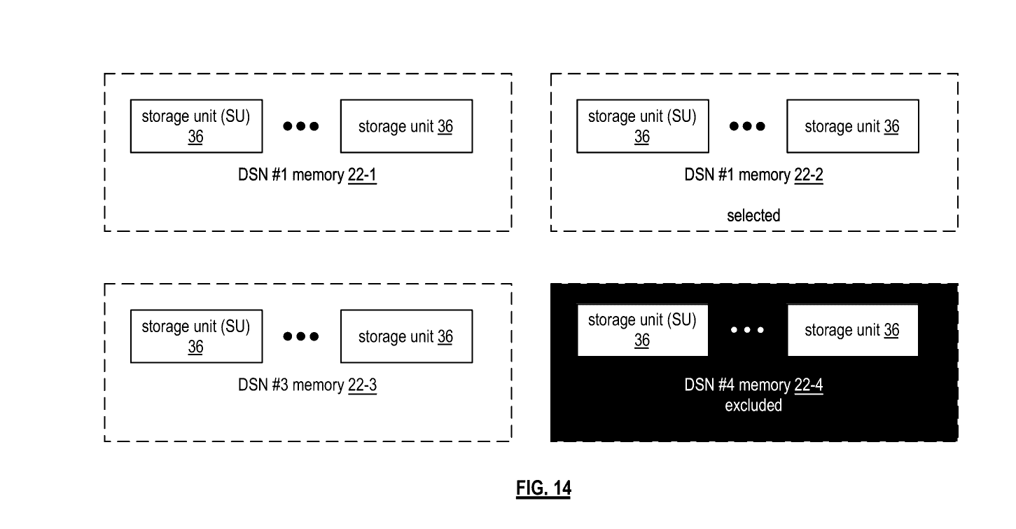

FIG. 14 is a schematic block diagram of an example of selecting one or more DSNs of a plurality of DSNs based on a storage directive. A requesting device of a dispersed storage network (DSN) (e.g., computing device 14) may send a write request regarding the storage of a data segment of a data object to a DSN processing unit (e.g., the processing module of computing device 16) that includes a storage directive. The requesting device determines the storage directive based on one or more of data type of the data object, DSN access restrictions of the requesting device, and a data storage report. The storage directive includes a list of storage units that are preferred for storage and a list of storage units that should be excluded from storage. The storage directive may also include one or more DSNs of a plurality of DSNs that should be included in or excluded from storage operations. DSN access restrictions refer to the identity of storage units of the DSN that the requesting device is authorized and/or is unauthorized to access. As another example of DSN access restrictions, the requesting device may maintain a list of the identity of one or more DSNs of a plurality of DSNs it is authorized to access and/or that it is unauthorized to access. Further, the requesting device's data storage report informs the requesting device of storage units and/or DSNs to include or exclude based on past storage operations.

Based on DSN access restrictions, data type, or the data storage report, the storage directive in this example wishes to exclude DSN #4 memory 22-4 and include DSN #1 memory 22-1 and DSN #2 memory 22-2. DSN #3 memory 22-3 is neither included nor excluded. The storage directive may further include a list of storage units to include and exclude within each of the included DSN memories in the manner discussed with reference to FIGS. 11-13.

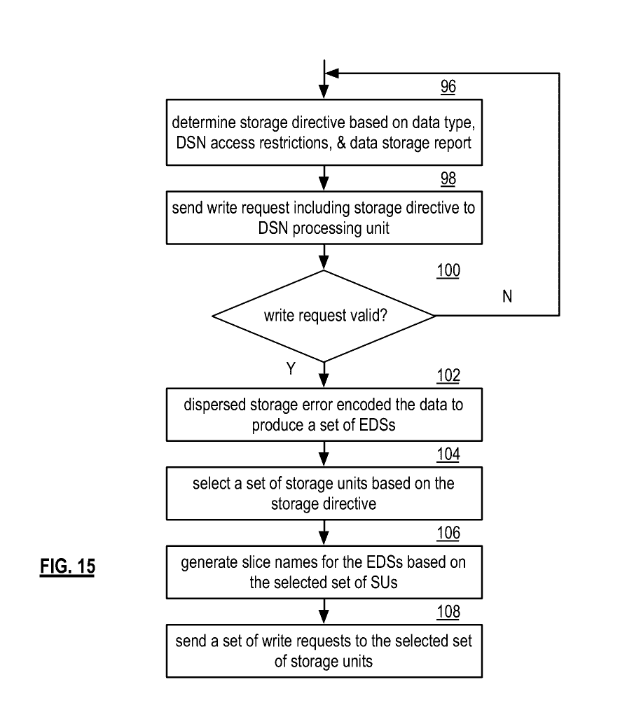

FIG. 15 is flowchart illustrating an example of performing a write request based on a storage directive of a requesting device. The method begins with step 96 where a requesting device of the DSN preparing to send a write request regarding storage of a data segment of a data object to a DSN processing unit, determines a storage directive based on one or more of data type of the data object, DSN access restrictions of the requesting device, and a data storage report. The storage directive includes a list of storage units that are preferred for storage and a list of storage units that should be excluded from storage. The storage directive may also include one or more DSNs of a plurality of DSNs that should be included in or excluded from storage operations.

The requesting device may wish to exclude or include certain storage units for several reasons. For example, the data type of the data object may necessitate a particular method of storage that is only provided by certain storage units or DSNs. As another example, DSN access restrictions may dictate which storage units the requesting device may write to. The requesting device may maintain a list of the identity of storage units of the DSN that it is authorized to access and/or that it is unauthorized to access. Further, the requesting device may maintain a list of the identity of one or more DSNs of a plurality of DSNs it is authorized to access and/or that it is unauthorized to access. Based on these DSN access restrictions, the requesting device can direct the write request to storage units and or DSNs that it is authorized to access. For instance, the requesting device may be unauthorized to write to storage units or DSNs that are located in certain regions or geographies due to regulatory compliance. In that case, the requesting device would add the storage units from those regions to an exclusion list in the storage directive.

Further, the requesting device's data storage report informs the requesting device of which storage units and/or DSNs to include or exclude based on past storage operations. The data storage report includes the identity of any storage units that have provided favorable and/or unfavorable write responses (e.g., the storage unit was stalled, overloaded, or was experiencing some other kind of performance issue) in the past. The data storage report keeps track of storage units that failed to provide write responses in the past (e.g., the storage unit was inoperable or never received the request due to a network connection issue). The data storage report also logs the storage units or DSNs that have been excluded in the past and storage units that. If the data storage report indicates that certain storage units are untrustworthy or do not meet performance requirements, the requesting device will add those storage units to the exclusion list in the storage directive.

When the requesting device determines the storage directive based on the data type of the data object, the DSN access restrictions of the requesting device, and the data storage report, the method continues with step 98 where the requesting device sends a write request that includes the storage directive to the DSN processing unit. The method then continues to step 100 where DSN processing unit validates the write request in light of the storage directive. For example, if the storage directive includes a list of storage units to include in the write request, the DSN processing unit verifies that the requesting device is in fact authorized to write to those storage units.

When the DSN processing unit determines that the write request is not valid in light of the storage directive at step 100, the method continues back to the beginning with step 96. When the DSN processing unit determines that the write request is valid in light of the storage directive, the method continues to step 102 where the DSN processing unit dispersed storage error encodes the data segment to produce a set of encoded data slices. The set of encoded data slices includes a pillar number of encoded data slices, where a decode threshold number of encoded data slices is required to recover the data segment, and the decode threshold number is less than the pillar number.

The method continues with step 104 where the DSN processing unit selects a set of storage units from a plurality of storage units based on the storage directive, where the selected set of storage units includes a storage unit from each pillar grouping of storage units of the pillar number of groupings of storage units of the plurality of storage units. Alternatively, or in addition to, the DSN processing unit may identify preferred storage units within each pillar grouping of storage units based on the storage directive. The DSN processing unit then obtains storage capability and reliability (e.g., available memory, latency, IO rate, percentage of time online, etc.) data of the preferred storage units. The DSN storage unit may then select the set of storage units from the preferred storage units in accordance with the storage capability and reliability data.

As another example, the storage directive may include the identity of a first storage unit for storing a first encoded data slice, the identity of a second storage unit of the selected set of storage units for storing a second encoded data slice of the set of encoded data slices, identity of a third storage unit of the selected set of storage units for storing a third encoded data slice of the set of encoded data slices, and the identity of further storage units to store additional encoded data slices of the set of encoded data slices. If the storage directive identifies which encoded data slices go to which storage units, the DSN processing unit simply follows that directive.

The method continues with step 106 where the DSN processing unit generates a set of slice names for the set of encoded data slices based on the selected set of storage units, where a first slice name is generated for a first encoded data slice of the set of encoded data slices for storage in a first storage unit of the set of storage units. This process continues for each encoded slice that will be stored in the selected set of storage units.

The method continues with step 108 where the DSN processing unit sends a set of write requests to the selected set of storage units, where a first write request of the set of write requests includes the first encoded data slice and the first slice name, and where the first write request is sent to the first storage unit. This process is continued until write requests are sent to all of the storage units in the selected set regarding the encoded data slices to be stored.

The requesting device will receive write responses from at least some of the storage units of the selected set of storage units in response to the write requests. Based on these write responses, the requesting device can update the data storage report to include the identity of storage units that provided a favorable write response, the identity of storage units that provided an unfavorable write response, the identity of storage units that provided no write response, and the identity of storage units not included in the selected set of storage units. For example, if a selected storage unit returns an unfavorable write response (e.g., the storage unit stalled or operated too slowly), the requesting device may use that information to adjust future storage directives (e.g., the requesting device may add the stalled or slow storage unit to the exclusion list if that storage unit has become unreliable or less desirable for storage).

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
determining, by a requesting device of a dispersed storage network (DSN), a storage directive regarding storage of a data segment of a data object based on one or more of: data type of the data object, DSN access restrictions of the requesting device, and a data storage report;
sending, by the requesting device, a write request regarding the data segment to a DSN processing unit of the DSN, wherein the write request includes the storage directive;
validating, by the DSN processing unit, the write request in light of the storage directive;
when the write request is valid:
dispersed storage error encoding the data segment to produce a set of encoded data slices, wherein the set of encoded data slices includes a pillar number of encoded data slices, wherein a decode threshold number of encoded data slices is required to recover the data segment, and wherein the decode threshold number is less than the pillar number;
selecting a set of storage units from a plurality of storage units based on the storage directive, wherein the selected set of storage units includes a storage unit from each pillar grouping of storage units of the pillar number of groupings of storage units of the plurality of storage units;
generating a set of slice names for the set of encoded data slices based on the selected set of storage units, wherein a first slice name is generated for a first encoded data slice of the set of encoded data slices for storage in a first storage unit of the set of storage units; and
sending a set of write requests to the selected set of storage units, wherein a first write request of the set of write requests includes the first encoded data slice and the first slice name, and wherein the first write request is sent to the first storage unit.

2. The method of claim 1, wherein the data storage report comprises one or more of:
identity of one or more storage units of the plurality of storage units that has provided a favorable write response to a past write request of a set of past write requests;
identity of one or more storage units of the plurality of storage units that has provided an unfavorable write response to a past write request of a set of past write requests; and
identity of one or more storage units of the plurality of storage units that provided no write response to a past write request of a set of past write requests; and
identity of one or more storage units of the plurality of storage units previously not included in a selected set of storage units of the plurality of storage units.

3. The method of claim 1, wherein the DSN access restrictions comprises:
identity of one or more sets of storage units with the DSN that the requesting device is prohibited from accessing;
identity of one or more preferred sets of storage units within the DSN that the requesting device is authorized to access;
identity of one or more DSNs of a plurality of DSNs that the requesting device is prohibited from accessing; and
identity of one or more preferred DSNs of the plurality of DSNs that the requesting device is authorized to access.

4. The method of claim 1, wherein the storage directive comprises one or more of:
a desired list of one or more storage units of the plurality of storage units that are preferred for storing an encoded data slice of the set of encoded data slices; and
an exclusion list of one or more storage units of the plurality of storage units that are not to store an encoded data slice of the set of encoded data slices.

5. The method of claim 1, wherein the storage directive comprises:
identity of the first storage unit for storing the first encoded data slice;
identity of a second storage unit of the selected set of storage units for storing a second encoded data slice of the set of encoded data slices; and
identity of a third storage unit of the selected set of storage units for storing a third encoded data slice of the set of encoded data slices.

6. The method of claim 1 further comprises:
receiving, by the requesting device, write responses from at least some of the storage units of the selected set of storage units; and
updating, by the requesting device, the data storage report to include:
identity of one or more storage units of the selected set of storage units that has provided a favorable write response to the write request of the set of write requests;
identity of one or more storage units of the selected set of storage units that has provided an unfavorable write response to the write request of the set of write requests; and
identity of one or more storage units of the selected set of storage units that has provided no write response to the write request of the set of write requests; and
identity of one or more storage units of the plurality of storage units not included in the selected set of storage units.

7. The method of claim 1, wherein the selecting the set of storage units comprises:
identifying, based on the storage directive, preferred storage units within each pillar grouping of storage units;
obtaining storage capability and reliability data of the preferred storage units; and
selecting the set of storage units from the preferred storage units in accordance with the storage capability and reliability data.

8. A computer readable memory comprises:
a first memory that stores operational instructions that, when executed by a requesting device of a dispersed storage network (DSN), cause the requesting device to:
determine a storage directive regarding storage of a data segment of a data object based on one or more of: data type of the data object, DSN access restrictions of the requesting device, and a data storage report;
send, a write request regarding the data segment to a DSN processing unit of the DSN, wherein the write request includes the storage directive;
a second memory that stores operational instructions that, when executed by the DSN processing unit of a dispersed storage network (DSN), cause the DSN processing unit to:
validate the write request in light of the storage directive;
when the write request is valid:
dispersed storage error encode the data segment to produce a set of encoded data slices, wherein the set of encoded data slices includes a pillar number of encoded data slices, wherein a decode threshold number of encoded data slices is required to recover the data segment, and wherein the decode threshold number is less than the pillar number;
select a set of storage units from a plurality of storage units based on the storage directive, wherein the selected set of storage units includes a storage unit from each pillar grouping of storage units of the pillar number of groupings of storage units of the plurality of storage units;
generate a set of slice names for the set of encoded data slices based on the selected set of storage units, wherein a first slice name is generated for a first encoded data slice of the set of encoded data slices for storage in a first storage unit of the set of storage units; and
send a set of write requests to the selected set of storage units, wherein a first write request of the set of write requests includes the first encoded data slice and the first slice name, and wherein the first write request is sent to the first storage unit.

9. The computer readable memory of claim 8, wherein the data storage report comprises one or more of:
identity of one or more storage units of the plurality of storage units that has provided a favorable write response to a past write request of a set of past write requests;
identity of one or more storage units of the plurality of storage units that has provided an unfavorable write response to a past write request of a set of past write requests; and
identity of one or more storage units of the plurality of storage units that provided no write response to a past write request of a set of past write requests; and
identity of one or more storage units of the plurality of storage units previously not included in a selected set of storage units of the plurality of storage units.

10. The computer readable memory of claim 8, wherein the DSN access restrictions comprises:
identity of one or more sets of storage units with the DSN that the requesting device is prohibited from accessing;
identity of one or more preferred sets of storage units within the DSN that the requesting device is authorized to access;
identity of one or more DSNs of a plurality of DSNs that the requesting device is prohibited from accessing; and
identity of one or more preferred DSNs of the plurality of DSNs that the requesting device is authorized to access.

11. The computer readable memory of claim 8, wherein the storage directive comprises one or more of:
a desired list of one or more storage units of the plurality of storage units that are preferred for storing an encoded data slice of the set of encoded data slices; and
an exclusion list of one or more storage units of the plurality of storage units that are not to store an encoded data slice of the set of encoded data slices.

12. The computer readable memory of claim 8, wherein a third memory stores operational instructions that, when executed by the requesting device, causes the requesting device to:
receive write responses from at least some of the storage units of the selected set of storage units; and
update the data storage report to include:
identity of one or more storage units of the selected set of storage units that has provided a favorable write response to the write request of the set of write requests;
identity of one or more storage units of the selected set of storage units that has provided an unfavorable write response to the write request of the set of write requests; and
identity of one or more storage units of the selected set of storage units that has provided no write response to the write request of the set of write requests; and
identity of one or more storage units of the plurality of storage units not included in the selected set of storage units.

13. The computer readable memory of claim 8, wherein the second memory further stores operational instructions that, when executed by the DSN processing unit, causes the DSN processing unit to select the set of storage units by:
identifying, based on the storage directive, preferred storage units within each pillar grouping of storage units;
obtaining storage capability and reliability data of the preferred storage units; and
selecting the set of storage units from the preferred storage units in accordance with the storage capability and reliability data.
